(19) United States
(12) Patent Application Publication
(10) Pub. No.: US 2012/0050226 A1
(43) Pub. Date: Mar. 1, 2012

(54) DISPLAY INPUT APPARATUS AND DISPLAY INPUT METHOD

(75) Inventor: Kazunori Kato, Shizuoka (JP)

(73) Assignee: TOSHIBA TEC KABUSHIKI KAISHA, Tokyo (JP)

(21) Appl. No.: 13/043,786

(22) Filed: Mar. 9, 2011

(30) Foreign Application Priority Data
Sep. 1, 2010 (JP) 2010-196026

(51) Int. Cl. G06F 3/042

(52) U.S. Cl. 345/175

(57) ABSTRACT

According to one embodiment, a display input apparatus includes a display screen. At least one array of light-emitting elements is provided along at least one edge of the display screen, the at least one array of light-emitting elements being configured to irradiate a light beam therefrom. At least one array of light-receiving elements is provided along an edge opposing the at least one edge of the display screen, the at least one array of light-receiving elements being configured to receive the light beam from the at least one array of light-emitting elements and further being configured to generate a detection signal indicating intensity of the received light. A control unit is configured to determine a potential of the detection signal, and further being configured to compensate the potential of the detection signal based on the intensity of the received light. A detection unit is configured to compare the compensated potential of the detection signal with a threshold so as to detect coordinates of a touch position thereby.

### CROSS-REFERENCE TO RELATED APPLICATIONS

This application is based upon and claims the benefit of priority from Japanese Patent Application No. 2010-196026, filed on Sep. 1, 2010, the entire contents of which are incorporated herein by reference.

### FIELD

Embodiments described herein relate generally to a display input apparatus with an image display function and an input function for input and manipulation of information on a touch panel, and a display input method for use in the display input apparatus, in which a light detection threshold can be adjusted based on the intensity of ambient light.

### BACKGROUND

Recently, a touch panel type of display screen has been widely used in touch POS (Point Of Sales) terminal or the like, which displays image data thereon and is also operable by directly touching the display screen with any object, for example, a finger. Typically, touching such a display screen with, for example, a finger, interrupts a certain infrared light beam (emitted from a light-emitting element) from being received by a light-receiving element. Coordinates at a location where the light beam is interrupted are detected as the touched position. In such an infrared beam type of touch panel, when the touch panel is exposed to daylight or other environments where an ambient light may be greater in intensity than the infrared light beam, light intensity more than a preset level may be inputted into an analog-digital converting circuit. This results in the failure to accurately detect the touched position.

When such a touch panel of the related art is exposed to a greater intensity of ambient light, a light beam with an intensity of more than a preset level may be introduced into a light-receiving element, such as a phototransistor. This may result in the introduction of excessive light intensity into an analog-digital converting circuit. Consequently, a problem may occur in that even if an operator touches a certain area on the touch panel with his/her finger, coordinates at a location touched with the finger may not be accurately detected.

### BRIEF DESCRIPTION OF THE DRAWINGS

FIG. 1 is an external view showing an example of the external appearance of a display input apparatus according to an illustrative embodiment.

FIG. 2 is a functional block diagram showing an example of an electrical configuration of a display input apparatus according to an illustrative embodiment.

FIG. 3 is a detailed functional block diagram showing an example of a touch detection unit of a display input apparatus.

FIG. 4 is a schematic conceptual view showing an example operation of a touch detection unit of a display input apparatus.

FIG. 5 is a waveform chart showing an example of detection signals detected by a touch detection unit of a display input apparatus.

FIG. 6 is a waveform chart showing another example of detection signals detected by a touch detection unit of a display input apparatus.

FIG. 7 is a flowchart showing an example of a compensation process which is performed by a touch detection unit of a display input apparatus according to an illustrative embodiment.

FIG. 8 is a flowchart showing an example of a compensation process which is performed by a touch detection unit of a display input apparatus according to another illustrative embodiment.

### DETAILED DESCRIPTION

According to first embodiment, a display input apparatus includes a display screen. At least one array of light-emitting elements is provided along at least one edge of the display screen, the at least one array of light-emitting elements being configured to irradiate a light beam therefrom. At least one array of light-receiving elements is provided along an edge opposing the at least one edge of the display screen, the at least one array of light-receiving elements being configured to receive the light beam from the at least one array of light-emitting elements and further being configured to generate a detection signal indicating intensity of the received light. A control unit is configured to determine a potential of the detection signal, and further being configured to compensate the potential of the detection signal based on the intensity of the received light. A detection unit is configured to compare the compensated potential of the detection signal with a threshold so as to detect coordinates of a touch position thereby.

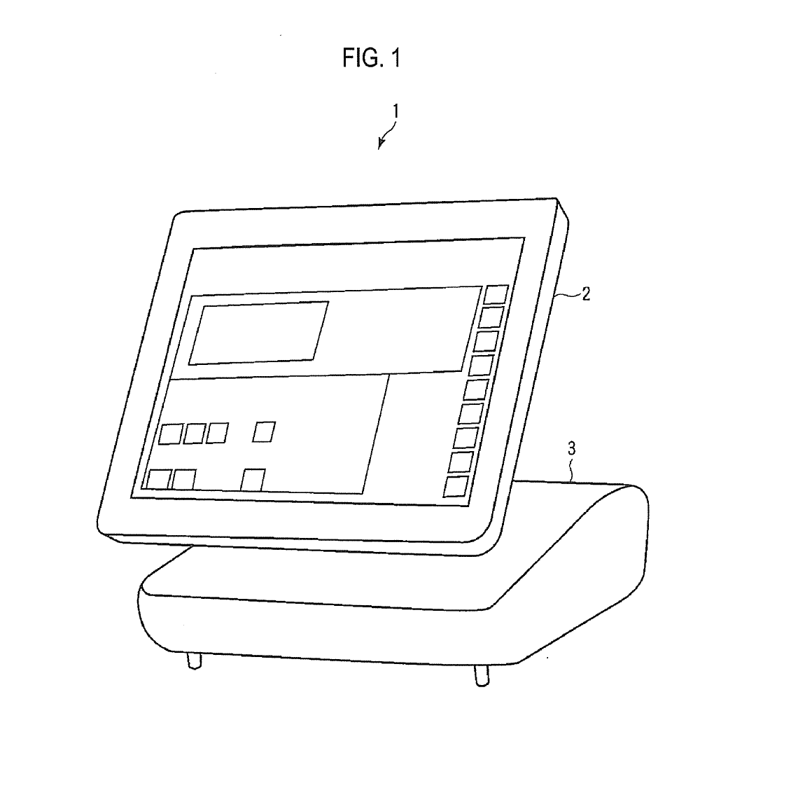

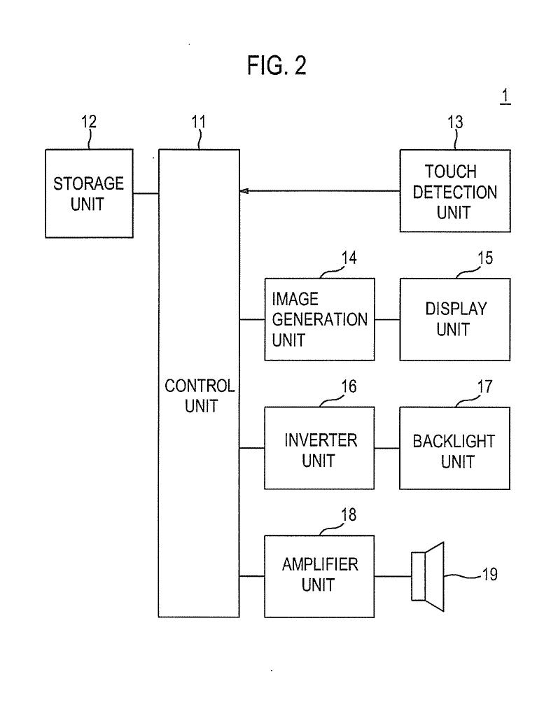

Embodiments will now be described in detail with reference to the drawings. FIG. 1 shows an example of the external appearance of a display input apparatus 1 according to an illustrative embodiment. The display input apparatus 1 shown in FIG. 1 may be used in, for example, a touch POS (Point Of Sales) terminal. As shown in FIG. 1, the display input apparatus 1 includes a display device 2 incorporating an image generation unit 14 and configured to display an image thereon, and a main body device 3 configured to tiltably hold the display unit 2 thereon. Further, as shown in FIG. 2, the display input apparatus 1 includes a control unit 11 configured to control the entire operation of the display input apparatus 1, and a storage unit 12 configured to store therein compensation data corresponding to an intensity level of an ambient light, or threshold compensation data. The display input apparatus 1 further includes a touch detection unit 13 configured to detect information associated with a touch operation performed by an operator on a touch panel, and an image generation unit 14 configured to generate information associated with an image to be displayed on a display unit 15. The display input apparatus 1 further includes the display unit 15 configured to display the image generated by the image generation unit 14 on, for example, a liquid crystal screen, and a back-light unit 17 configured to illuminate the liquid crystal screen of the display unit 15 from the back side thereof. The display input apparatus 1 further includes an inverter unit 16 configured to supply a drive current to the back-light unit 17, an amplifier unit 18 configured to amplify an audio signal associated with the touch operation, and a speaker 19 to output the audio signal provided from the amplifier unit 18.

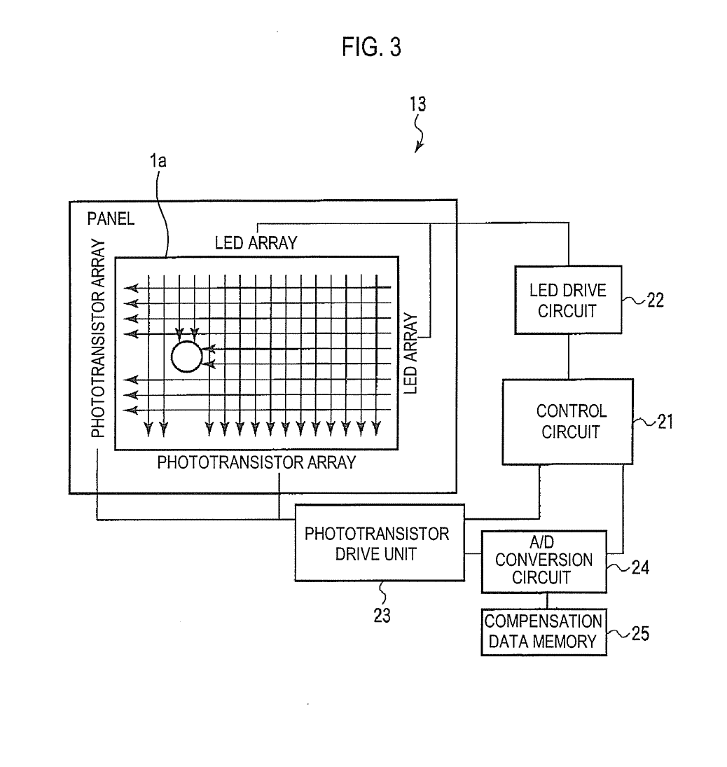

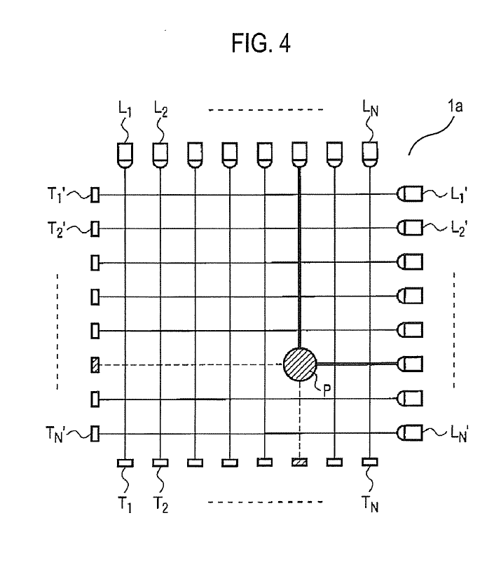

In the following, a detailed description of a configuration and operation of the touch detection unit 13 of the display input apparatus 1 according to an illustrative embodiment will be provided with reference to FIGS. 3 to 5. As shown in FIGS. 3 and 4, two linear arrays of light-emitting elements (e.g., light-emitting diodes: LEDs) L₁˜L_{N} and L₁′˜L_{N}′ are respectively disposed along the top and right edges of a panel 1a, and two linear arrays of light-receiving elements (e.g., phototransistors or other type of sensing devices) T₁˜T_{N} and T₁′˜T_{N}′ are respectively disposed along the opposing edges (i.e., the bottom and the left edges) of the panel 1a. The touch detection unit 13 includes a control circuit 21 configured to control the operation of the touch detection unit 13, and a LED drive circuit 22 configured to drive the LEDs L₁˜L_{N} and the LEDs L₁˜′L_{N}′. The touch detection unit 13 further includes a phototransistor drive unit 23 configured to drive the phototransistors T₁˜T_{N} and the phototransistors T₁′˜T_{N}′. The phototransistor drive unit 23 may be further configured to process a waveform detected by the phototransistors T₁˜T_{N} and the phototransistors T₁′˜T_{N}′. The touch detection unit 13 further includes an analog-to-digital (A/D) conversion circuit 24 configured to convert analog detection signals provided from the phototransistor drive unit 23 into digital signals, and a compensation data memory 25 to configured store therein compensation data to be used in compensation process for ambient light, which will be explained later.

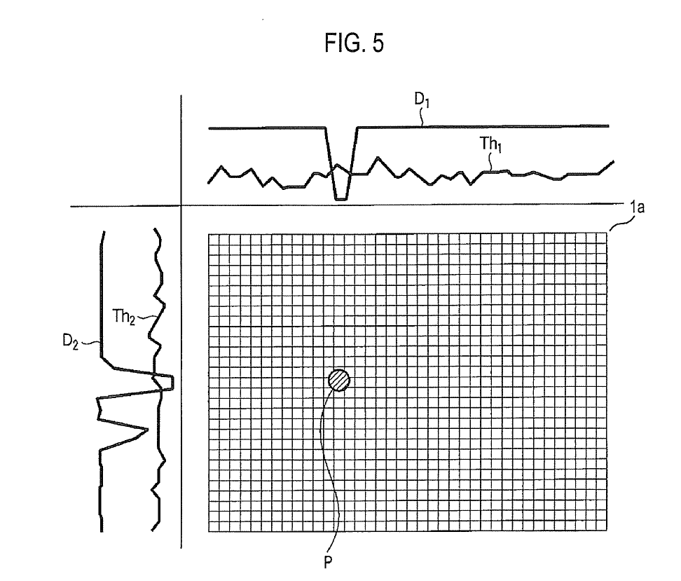

As described above with reference to FIG. 4, the LEDs L₁˜L_{N}, L₁′˜L_{N}′ and the phototransistors T₁˜T_{N}, T₁′˜T_{N}′ are provided along the periphery of the panel 1a. When an operator touches a contact point P (e.g., a point where two pairs of LEDs/phototransistors cross) on the panel 1a with his/her finger, a stylus, or other pointing device, light beams emitted from a certain vertically arranged LED and a certain horizontally arranged LED (disposed around the top and right edges of the panel 1a, respectively) are interrupted. Then, two phototransistors, which are vertically and horizontally disposed opposite the above two LEDs, respectively, along the bottom and left edges of the panel 1a, detects coordinates of the contact point P where the light beam is interrupted. As shown in FIG. 5, detection signals D1 and D2 detected by the phototransistors have low values at the contact point P. By determining that the values (or potentials) of detection signals D1 and D2 at the contact point P are smaller than thresholds Th1 and Th2, respectively, the touch detection unit 13 can detect the coordinates of the contact point P touched by the operator's finger.

In the following, a detailed description will be provided as an example of compensation process performed by the touch detection unit 13. For example, if ambient light has high intensity (e.g., when daylight enters indoor), signals detected by the phototransistors T₁′˜T_{N}′ of the touch detection unit 13 may have an abnormally-elevated potential. This causes an error in detecting the coordinates of the contact point P. To address this, the touch detection unit 13 according to an illustrative embodiment compensates detection signals (and also thresholds) in response to a fluctuation in intensity of ambient light. Such a compensation process may be performed either in a situation where the ambient light has excessive intensity or in a situation where the ambient light has significantly low intensity.

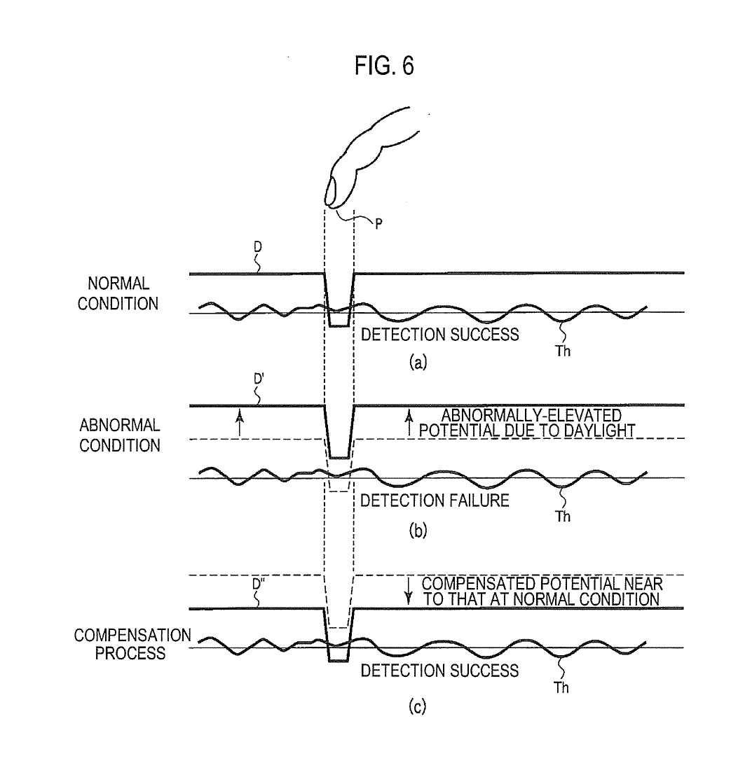

A detailed description of the detection error correction and the compensation process will be given with reference to FIG. 6. FIG. 6 shows a normal condition (a) (e.g., an ideal condition) in which the panel 1a is exposed to a normal ambient light. As shown in the upper waveform chart of FIG. 6, when the operator (or his/her finger) touches the contact point P, a detection signal D has a normal potential which is equal to or smaller than a threshold Th at the contact point P. In this case, the touch detection unit 13 may correctly detect the coordinates of the contact point P. Further, FIG. 6 shows an abnormal condition (b) in which the panel 1a is exposed to ambient light of high intensity. As shown in the middle waveform chart of FIG. 6, when the operator touches the contact point P, a detection signal D′ has an abnormally-elevated potential which is higher than the threshold Th even at the contact point P. In this case, the touch detection unit 13 may not correctly detect the coordinates of the contact point D, which causes a detection error.

Therefore, in first embodiment as shown in the lower waveform chart of FIG. 6, the touch detection unit 13 compensates a detection signal D″ (having an abnormally-elevated potential) based on compensation data previously stored in the compensation data memory 25, through the control circuit 21 and the A/D converter 24. Such compensation adjusts the detection signal D″ to be approximately same as a potential detected under the normal condition (a) (e.g., the ideal condition), thereby correctly detecting the coordinates of the contact point P.

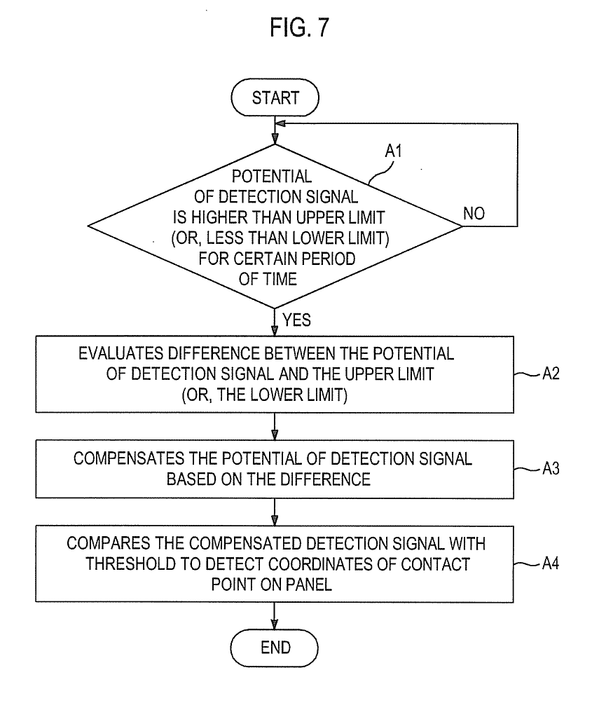

In the following, a detailed description will be made as to an example of compensation process according to an illustrative embodiment with reference to FIG. 7. The control circuit 21 of the touch detection unit 13 continuously scans a potential of a detection signal by the phototransistors T₁˜T_{N}, T₁′˜T_{N}′. If the potential of the detection signal is higher than a predetermined upper limit (or less than a predetermined lower limit) with respect to a normal level for a certain period of time (e.g., 15 seconds or higher), the control circuit 21 determines that the detection signal should be compensated (Act A1). It should be noted that the period of time (e.g., for 15 seconds or higher) for checking the potential of the detection signal is set such that it can be determined whether the potential of the detection signal is varied due to a change in intensity of ambient light or due to a temporary change, for example, a displacement of the operator's finger on the panel 1a.

Thereafter, the control circuit 21 stores a current detection signal obtained by the phototransistors T₁˜T_{N}, T₁′˜T_{N}′ in a storage area such as the compensation data memory 25. Also, for example, the control circuit 21 calculates a difference between the potential of the current detection signal and the predetermined upper limit (or the predetermined lower limit) (Act A2). In first embodiment, compensation data corresponding to the difference may be selected and extracted from data previously stored in the compensation data memory 25. Thereafter, the control circuit 21 provides the extracted compensation data to the A/D converter 24 where a compensation is performed on the current detection signal based on the compensation data (e.g., to decrease the potential of the detection signal) (Act A3). Then, the control circuit 21 compares the compensated detection signal with a threshold Th, thereby detecting the coordinates of the contact point P which is pressed by the operator (Act A4).

In the above embodiment, the control circuit 21 obtains compensation data by calculating the difference between the potential of the current detection signal and the predetermined upper limit (or predetermined lower limit). Alternatively, the control circuit 21 may previously store a plurality of compensation data corresponding to different intensities of ambient light in the compensation data memory 25. In response to an intensity of current ambient light, the control circuit 21 may extract a compensation data corresponding to the intensity from the compensation data memory 25. As such, the potential of the current detection signal can be compensated in real time.

In this embodiment, the compensation process as described above is separately performed on respective detection signals obtained by operating respective pairs of LEDs and phototransistors. For example, if a 12-inch size of the panel is provided to include about 50 pairs of LEDs and phototransistors, the control circuit 21 may constantly perform 50 detection/compensation processes in parallel.

In first embodiment, the compensation data memory 25 may be implemented in the form of a ring buffer to store a new reference brightness and corresponding compensation data on an as-needed basis. Further, a reference output from the touch panel, including a fluctuation in output from a sensor formed by a LED and phototransistor pair (which is measured in product manufacturing), may be stored in the compensation data memory 25, the storage unit 12 or the like. Such reference output may be added to the threshold Th, which then have, for example, a jagged waveform incorporating the fluctuation, as shown in FIG. 5.

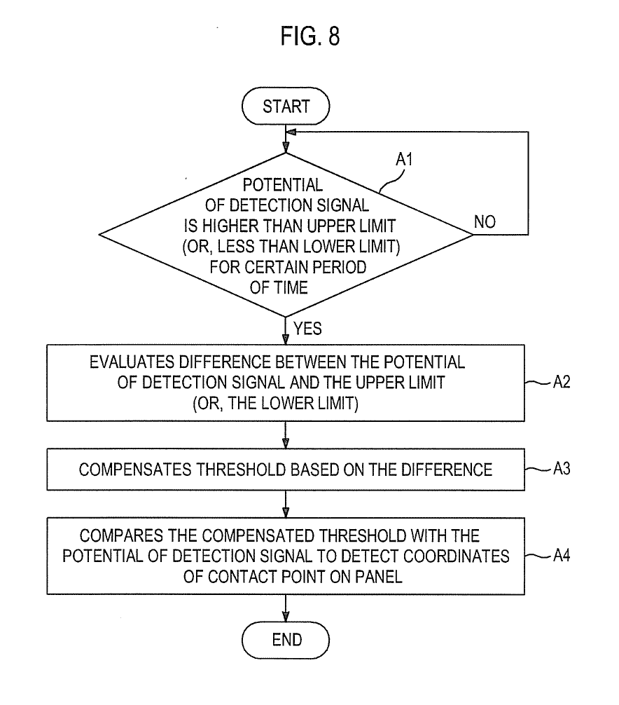

FIG. 8 is a flowchart showing an example of a compensation process which is performed by a touch detection unit of a display input apparatus according to another illustrative embodiment. As explained in the flowchart of FIG. 8, the thresholds are compensated in response to ambient light instead of compensating signals measured at the phototransistors, thereby performing a compensation process according to the ambient light.

Specifically, the control circuit 21 stores a detection signal currently obtained by operating a LED and phototransistor pair in the compensation data memory 25. In a similar manner as shown in FIG. 7 (and also shown in FIG. 8), the control circuit 21 determines whether a potential of the current detection signal is higher than a predetermined upper limit (or less than a predetermined lower limit) (Act A1). If the determination result at Act A1 is YES, the control circuit 21 determines that the current detection signal needs to be compensated. Then, the control circuit 21 calculates a difference between the potential of the current detection signal and the predetermined upper limit (or the predetermined lower limit) (Act A2). As described above, compensation data corresponding to the difference may be selected and extracted from data previously stored in the compensation data memory 25. Thereafter, the control circuit 21 provides the extracted compensation data to the A/D converter 24 where a compensation is performed on a threshold Th based on the compensation data (e.g., to increase or decrease the magnitude of the threshold Th) (Act A3′). Subsequently, the control circuit 21 compares the compensated threshold Th with the current detection signal, thereby detecting coordinates of a contact point P pressed by the operator (Act A4′). As a result, the control circuit 21 adaptively compensates the threshold Th in response to an intensity of ambient light, thereby correctly detecting the coordinates of the contact point P on the panel 1a, without being affected by the influence of ambient light.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display input apparatus comprising:
a display screen;
at least one array of light-emitting elements provided along at least one edge of the display screen, the at least one array of light-emitting elements being configured to irradiate a light beam therefrom;
at least one array of light-receiving elements provided along an edge opposing the at least one edge of the display screen, the at least one array of light-receiving elements being configured to receive the light beam from the at least one array of light-emitting elements and further being configured to generate a detection signal indicating intensity of the received light;
a control unit configured to determine a potential of the detection signal, and further being configured to compensate the potential of the detection signal based on the intensity of the received light; and
a detection unit configured to compare the compensated potential of the detection signal with a threshold so as to detect coordinates of a touch position thereby.

2. The apparatus of claim 1, further comprising a storage unit configured to store therein, the detection signal and compensation data corresponding to the detection signal,
wherein the control unit is configured to compensate the potential of the detection signal based on the compensation data stored in the storage unit.

3. The apparatus of claim 2, wherein the storage unit previously stores therein a plurality of compensation data corresponding to respective intensities of light,
wherein the control unit is configured to extract compensation data corresponding to the potential of the detection signal from the plurality of compensation data stored in the storage unit, and further configured to compensate the potential of the detection signal based on the extracted compensation data.

4. The apparatus of claim 2, wherein the storage unit is a ring buffer memory.

5. The apparatus of claim 1, wherein the control unit is configured to compensate the potential of the detection signal, when the potential of the detection signal is higher than a predetermined upper limit or less than a predetermined lower limit for a fixed period of time.

6. The apparatus of claim 5, wherein the fixed period of time is 15 seconds or higher.

7. The apparatus of claim 1, wherein the control unit is configured to compensate the potential of the detection signal, based on magnitudes of respective detection signals produced by the at least one array of light-sensing elements.

8. The apparatus of claim 1, wherein the threshold includes a jagged waveform incorporating a fluctuation in output from a sensing device formed by a combination of the at least one array of light-emitting elements and the at least one array of light-receiving elements.

9. The apparatus of claim 1, wherein the control unit is further configured to compensate a threshold based on the intensity of the received light, and
wherein the detection unit is configured to compare the potential of the detection signal with the compensated threshold so as to detect coordinates of the touch position thereby.

10. The apparatus of claim 9, further comprising a storage unit configured to store therein, the detection signal and compensation data corresponding to the detection signal,
wherein the control unit is configured to compensate the threshold based on the compensation data stored in the storage unit.

11. A display input method comprising:
irradiating a light beam from at least one array of light-emitting elements provided along at least one edge of a display screen;
receiving the light beam from the at least one array of light-emitting elements using at least one array of light-receiving elements to generate a detection signal indicating intensity of the received light, the at least one array of light-sensing elements being provided along an edge opposing the at least one edge on the display screen;
compensating a potential of the detection signal based on the intensity of the received light; and
comparing the compensated potential of the detection signal with a threshold so as to detect coordinates of a touch position thereby.

12. The method of claim 11, further comprising storing in a storage unit, the detection signal and compensation data corresponding to the detection signal,
wherein the compensating includes compensating the potential of the detection signal based on the compensation data stored in the storage unit.

13. The method of claim 12, wherein the storing includes storing previously in a storage unit a plurality of compensation data corresponding to respective intensities of light, and
wherein the compensating includes extracting compensation data corresponding to the potential of the detection signal from the plurality of compensation data stored in the storage unit, and compensating the potential of the detection signal based on the extracted compensation data.

14. The method of claim 11, wherein the compensating includes compensating the potential of the detection signal, when the potential of the detection signal is higher than a predetermined upper limit or less than a predetermined lower limit for a fixed period of time.

15. The method of claim 14, wherein the fixed period of time is 15 seconds or higher.

16. The method of claim 11, wherein the compensating includes compensating the potential of the detection signal, based on magnitudes of respective detection signals produced by the at least one array of light-sensing elements.

17. The method of claim 11, wherein the compensating includes compensating a threshold based on the intensity of the received light, and
wherein the comparing includes comparing the potential of the detection signal with the compensated threshold to detect coordinates of the touch position.

18. The method of claim 17, further comprising storing in a storage unit the detection signal and compensation data corresponding to the detection signal,
wherein the compensating includes compensating the threshold based on the compensation data stored in the storage unit.

19. The method of claim 5, wherein the threshold includes a jagged waveform incorporating a fluctuation in output from a sensing device formed by a combination of the at least one array of light-emitting elements and the at least one array of light-sensing elements.

20. A computer-readable storage medium storing instructions that, when executed by a computer, cause the computer to perform the operations of:
irradiating a light beam from at least one array of light-emitting elements provided along at least one edge of a display screen;
receiving the light beam from the at least one array of light-emitting elements using at least one array of light-receiving elements to generate a detection signal indicating intensity of the received light, the at least one array of light-sensing elements being provided along an edge opposing the at least one edge on the display screen;
compensating a potential of the detection signal based on the intensity of the received light; and
comparing the compensated potential of the detection signal with a threshold so as to detect coordinates of a touch position thereby.
